(19) United States
(12) Patent Application Publication
(10) Pub. No.: US 2007/0188424 A1
(43) Pub. Date: Aug. 16, 2007

(54) Portable terminal device

(76) Inventors: Norio Okada, Kanagawa (JP); Sachio Aoyama, Kanagawa (JP); Toshinari Suo, Kanagawa (JP); Takayuki Miyazawa, Kanagawa (JP); Naoshi Tsunehiro, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/592,417

(22) PCT Filed: Mar. 11, 2005
(86) PCT No.: PCT/JP05/04313

§ 371 Date: Sep. 11, 2006

(30) Foreign Application Priority Data
Mar. 12, 2004 (JP) 2004-070449
Jul. 14, 2004 (JP) 2004-206863

(51) Int. Cl. G09G 3/32

(52) U.S. Cl. 345/82

(57) ABSTRACT

It is an object of the invention to provide a portable terminal device in which a display of a high visual effect can be performed.

The portable terminal device of the invention has: plural light emitting elements 11; and a controlling section 21 which selectively drives the respective plural light emitting elements 11 to cause the plural light emitting elements 11 to perform a matrix display based on display data.

### TECHNICAL FIELD

The present invention relates to a portable terminal device having a display section.

### BACKGROUND ART

Conventionally, a portable telephone device, a PDA, and other portable terminal devices in which a housing is configured so as to be foldable, a main display section that is a first display section is attached to a portion that is positioned inside when the housing is folded, and a sub-display section that is a second display section is attached to a portion that is exposed to the outside even when the housing is folded are put into practical use (for example, see Patent Reference 1). For example, a portable telephone device is configured so that the main display section can arbitrarily display the calling partner's telephone number, the partner telephone directory, the communication history, and other information, and the sub-display section can display the time during a standby period, the calling partner at call incoming, and the like. During a standby period, therefore, the time can be seen in the sub-display section. At call incoming, the calling partner can be identified through the sub-display section, and thereafter the call can be answered. In a state where the housing is opened, the partner telephone directory, the communication history, the telephone number at calling, and the like can be arbitrarily displayed.

In all conventional portable terminal devices, however, liquid crystal display devices or the like are used as both the main display section and the sub-display section, and, in the sub-display section, it is often that the displaying area is very smaller than that of the main display section because of the attachment area, thereby producing a problem in that it is difficult to check the displayed contents. In a device of this kind, a sub-display section is attached to the outer face of a housing as if to say that there is a sub-display section, and, even when the apparatus is intended to be designed in a neat manner, the design is naturally restricted (for example, see Patent Reference 1). By contrast, a large light emitting diode display device is known in which many light emitting diodes are arranged in a matrix to display characters, numerals, a pattern, or the like. However, such a device is used as a display device which displays a relatively large pattern such as “WORKING” in road maintenance, and not used in a portable telephone, a PDA, and other portable terminal devices (for example, see Patent Reference 2).

Patent Reference 1: JP-A-2003-198675 (page 8, FIG. 1)

Patent Reference 2: JP-A-7-311554 (pages 2 and 3, FIG. 3)

### DISCLOSURE OF THE INVENTION

### Problems that the Invention is to Solve

In a display device, usually, it is intended to display a larger amount of information, hence enhancement of resolution is advanced. Therefore, pixel pitches are narrowed, and also the pixel size tends to be reduced. In the case where a display device is mounted on a portable terminal device, particularly, the size of the display device itself is reduced, and therefore the pixel size is further reduced. When the pixel size is reduced, the size of information which can be expressed by one pixel is reduced. Therefore, there is a problem in that the visual effect is lowered.

The invention has been conducted in view of the above-discussed circumstances. It is an object of the invention to provide a portable terminal device in which a display of a high visual effect can be performed.

It is another object of the invention to provide a portable terminal device in which standby information such as the time during a standby period, the calling partner at call incoming, and the like are displayed largely and clearly on a housing itself.

### MEANS FOR SOLVING THE PROBLEM

The portable terminal device of the invention comprises: plural light emitting elements; and light emitting element driving means for selectively driving the respective plural light emitting elements to cause the elements to perform a display based on display data. According to the configuration, the portable terminal device comprises the light emitting element driving means for selectively driving the respective plural light emitting elements to cause the elements to perform a display based on display data, whereby a display can be performed while expanding the pixel size, so that a display of a high visual effect can be performed.

Furthermore, the portable terminal device of the invention comprises a housing having a transparent cover, the plural light emitting elements are arranged between the transparent cover and the housing, and the light emitting element driving means selectively drives the respective plural light emitting elements to cause the elements to display information. According to the configuration, information can be largely displayed by arranged light emitting members, and the displayed information is displayed so as to be defined against the transparent cover. Therefore, the portable terminal device has a function that it is easily viewable.

Furthermore, in the portable terminal device of the invention, the light emitting elements are LEDs or organic ELs. According to the configuration, since the light emitting elements are LEDs, a bright display can be performed, so that a display of a higher visual effect can be performed. Moreover, it is possible to provide a portable terminal device in which the power consumption is small, and which has a long life. Since the light emitting elements are organic ELs, miniaturization and cost reduction are enabled.

The portable terminal device of the invention comprises incoming processing means for, based on display data attached to an electronic mail, causing the display to be performed at a timing of incoming of the electronic mail. According to the configuration, based on display data attached to an electronic mail, a display is performed at a timing of incoming of the electronic mail, whereby the display data can be displayed at a timing of incoming. Therefore, incoming of the electronic mail can be informed to the user. When the sender attaches display data of a favorite design to an electronic mail to be transmitted, the display data of the sender's favorite design can be displayed before the recipient reads the electronic mail. Therefore, the feeling, sensitivity, and the like of the sender can be previously understood by the recipient.

Furthermore, the portable terminal device of the invention comprises event sensing means for sensing an event, and a table showing correspondences between the event and display data, and the light emitting element driving means refers the table, and causes a display based on display data corresponding to a sensed event to be performed. According to the configuration, the light emitting element driving means refers the table, and causes a display based on display data corresponding to a sensed event to be performed, thereby performing a corresponding display each time when various kinds of events occur. Therefore, the portable terminal device can change the display while reacting with the event as if it is a creature. When the user sees the display corresponding to the event, the user can intuitively understand which event occurred.

Furthermore, the portable terminal device of the invention has a communication function, the event sensing means senses incoming, and, during incoming, the light emitting element driving means causes a display based on display data corresponding to an incoming event to be performed. According to the configuration, during incoming, the light emitting element driving means performs a display based on display data corresponding to an incoming event. When the user sees the display, therefore, the user can intuitively understand that incoming is performed.

Furthermore, the portable terminal device of the invention has a communication function, the event sensing means senses communication, and, during communication, the light emitting element driving means causes a display based on display data corresponding to a communication event to be performed. According to the configuration, during communication, the light emitting element driving means causes a display based on display data corresponding to a communication event, to be performed. When the user sees the display, therefore, the user can intuitively understand that communication is performed.

Furthermore, the portable terminal device of the invention comprises sensors which sense a voice, an image, a radio wave, a remaining power of a battery, and the like, and a table showing correspondences between sense outputs of the sensors and display data, and the light emitting element driving means refers the table, and causes a display based on display data corresponding to the sense outputs to be performed. According to the configuration, the light emitting element driving means refers the table, and causes a display based on display data corresponding to sense results to be performed, thereby performing a display corresponding to a change of sense results of various kinds of sensors. Therefore, the portable terminal device can change the display while reacting with sense results as if it is a creature.

Furthermore, the portable terminal device of the invention comprises a function of getting a time and a date, and a table showing correspondences between the time and the date, and display data, and the light emitting element driving means refers the table, and performs a display based on display data corresponding to the time and the date. According to the configuration, the light emitting element driving means refers the table, and causes a display based on display data corresponding to the time and the date to be performed. Therefore, it is possible to perform a display which is suitable for the time slot, the season, or the like.

Furthermore, the portable terminal device of the invention comprises means for producing and changing display data. According to the configuration, means for producing and changing display data is disposed, so that display data of the user's favorite design can be produced, and prepared display data can be changed to those of the user's favorite design. Therefore, the portable terminal device can be customized while display data which express the own sensitivity, feeling, sense, and the like are displayed.

In the portable terminal device of the invention, furthermore, the light emitting element driving means causes plural display data to be sequentially displayed. According to the configuration, a display section sequentially displays plural display data, thereby it is possible to clearly display a motion picture.

### EFFECT OF THE INVENTION

According to the portable telephone device of the invention, light emitting element driving means for selectively driving respective plural light emitting elements to cause the elements to perform a display based on display data is disposed, whereby a display can be performed while expanding the pixel size. Therefore, a display of a high visual effect can be performed.

### BRIEF DESCRIPTION OF THE DRAWINGS

FIG. 1 is a perspective view of a state where housings of a portable terminal device of a first embodiment of the invention are opened.

FIG. 2 is a perspective view of a state where the housings of the portable terminal device of the first embodiment of the invention are closed.

FIG. 3 is a partial section view of the portable terminal device of the first embodiment of the invention.

FIG. 4 is a block diagram schematically showing the electric configuration of the portable terminal device of the first embodiment of the invention.

FIG. 5 is a flowchart showing the operation of the portable terminal device of the first embodiment of the invention.

FIG. 6 is a perspective view of a state where a time is displayed in the portable terminal device of the first embodiment of the invention.

FIG. 7 is a flowchart showing the operation of incoming in the portable terminal device of the first embodiment of the invention.

FIG. 8 is a perspective view of a state of incoming of an electronic mail in a portable terminal device of a second embodiment of the invention.

FIG. 9 is a perspective view of an audio CD in a portable terminal device of a third embodiment of the invention.

FIG. 10 is a perspective view of a state where the audio CD is reproduced in the portable terminal device of the third embodiment of the invention.

FIG. 11(a) is an external view of a folded state of a portable telephone device of a fourth embodiment of the invention, and FIG. 11(b) is a diagram of a sub-display section.

FIG. 12 is a view showing example (1) of a matrix display in an emotion area in the fourth embodiment of the invention.

FIG. 13 is a view showing example (2) of the matrix display in the emotion area in the fourth embodiment of the invention.

FIG. 14 is a view showing example (3) of the matrix display in the emotion area in the fourth embodiment of the invention.

FIG. 15 is a view showing example (4) of the matrix display in the emotion area in the fourth embodiment of the invention.

FIG. 16 is an information diagram of a motion picture information format in the fourth embodiment of the invention.

FIG. 17 is a flowchart showing correction and a storing operation of sub-display section data of the portable telephone device of the fourth embodiment of the invention.

FIG. 18 is a flowchart showing an automatic reproducing and displaying operation at call incoming of an electronic mail in the portable telephone device of the fourth embodiment of the invention.

### DESCRIPTION OF REFERENCE NUMERALS AND SIGNS

1, 2 housing
1a transparent cover (jacket)
3 hinge
4 main display section
5 through hole for receiver
6 multidirectional operation key
7 function key
8 numeric keypad
9 operation section
10 through hole for microphone
11 light emitting element
12 printed circuit board
13 sub-display section
14 radio transmitting and receiving section
15 audio signal inputting and outputting section
16 microphone
17 receiver
18 calling signal outputting section
19 speaker
20 vibrator
21 controlling section
22 electronic telephone directory memory
31 information area
32 emotion area

### BEST MODE FOR CARRYING OUT THE INVENTION

Hereinafter, the best mode for carrying out the invention will be described with reference to the drawings.

### Embodiment 1

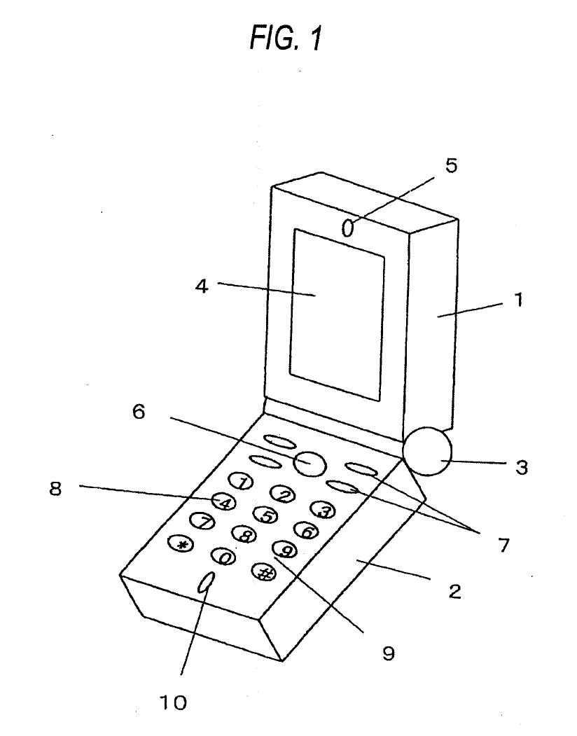

FIG. 1 is a perspective view a portable terminal device of a first embodiment of the invention.

As shown FIG. 1, the portable terminal device of the first embodiment of the invention has housings 1, 2 which are formed into a box-like shape, and a hinge 3 which connects them together in an openable and closable manner.

In a face which constitutes the inner side of the housing 1 in a state where the housings are closed, the terminal has: a main display section 4 such as a liquid crystal display device which displays various kinds of information;

and a through hole 5 for a receiver. In a face which constitutes the inner side of the housing 2 in a state where the housings are closed, the terminal has: an operation section 9 configured by a multidirectional operation key 6, function keys 7, a numeric keypad 8, and the like; and a through hole 10 for microphone.

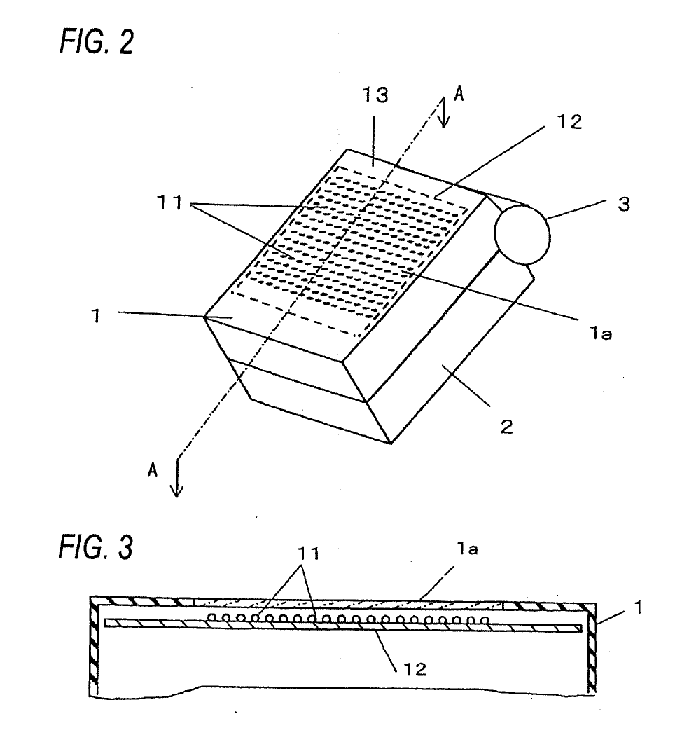

FIG. 2 is a perspective view of a state where the housings 1, 2 of the portable terminal device are closed, and FIG. 3 is a section view of the housing 1 of the portable terminal device taken along A-A in FIG. 2. Both of the housings 1, 2 are configured by a molded product of plastic. A middle portion of a face which constitutes the outer side of the housing 1 in a state where the housings are closed is configured so as to be covered by a transparent cover 1a. As shown in FIGS. 2 and 3, a printed circuit board 12 is disposed inside the housing 1 so as to be opposed to the transparent cover 1a, and plural light emitting elements 11 such as plural light emitting diodes (LEDs) are attached onto the printed circuit board 12. The transparent cover 1a is semi-translucent so that the light emitting elements 11 cannot be seen when they are lighted off.

The plural light emitting elements 11 have a function as a sub-display section 13 which displays a standby display during a standby period, an incoming display at call incoming, and the like.

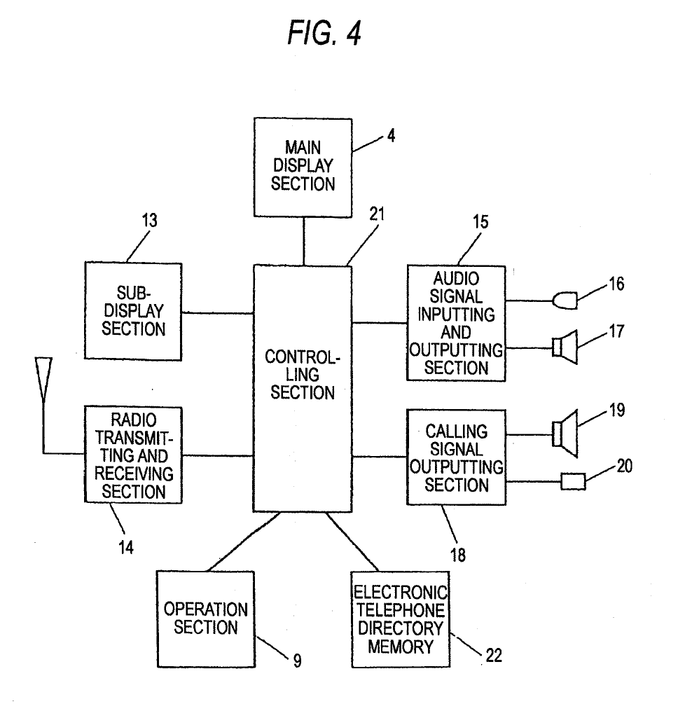

FIG. 4 is a block diagram schematically showing the electric configuration of the portable terminal device of the embodiment. In addition to the main display section 4, the sub-display section 13, the operation section 9, and the like, the portable terminal device of the embodiment further comprises: a radio transmitting and receiving section 14 which performs radio transmission and reception with respect to the partner; an audio signal inputting and outputting section 15 which receives and outputs an audio signal when communication with the partner is performed; a microphone 16; a receiver 17; a calling signal outputting section 18 which, when the partner is calling, outputs a calling signal; a speaker 19 which outputs a calling tone; a vibrator 20 which vibrates the housings 1, 2 at calling; a controlling section 21 which comprehensively controls these components; an electronic telephone directory memory 22 which holds telephone numbers, names, and the like; etc.

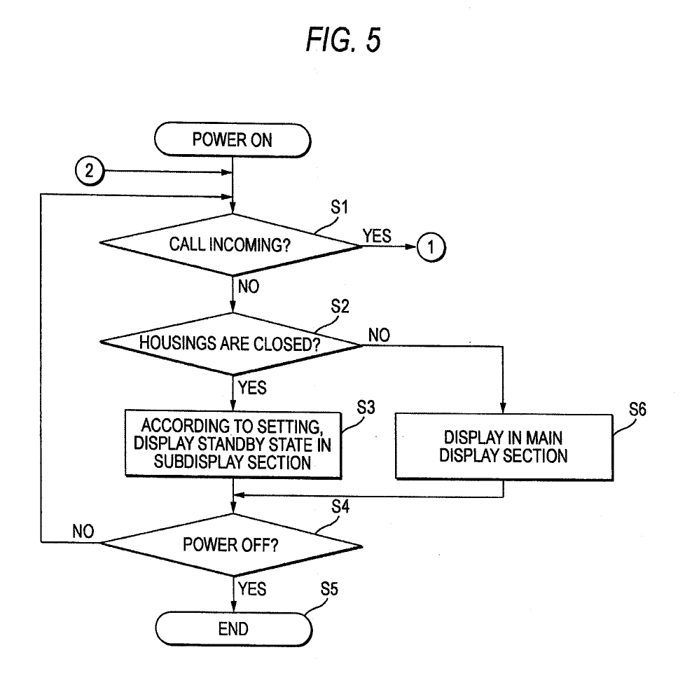

Next, the operation of the thus configured portable terminal device of the embodiment will be described in detail with reference to FIGS. 5, 6, and 7.

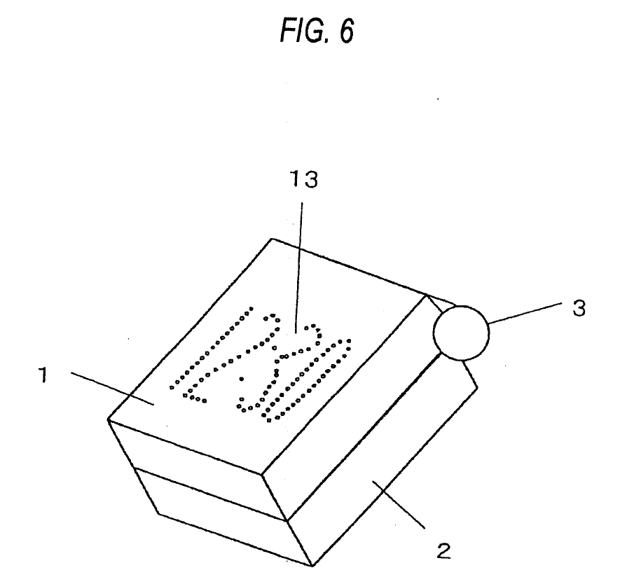

FIG. 5 is a flowchart showing the operation of the portable terminal device of the embodiment of the invention. In the portable terminal device of the embodiment, when the terminal is in a standby state and incoming is not performed (step S1), and in a state where the housings 1, 2 are closed (step S2), the time, characters, a pattern, or the like is displayed in the sub-display section 13 (step S3). Namely, although not illustrated, the portable terminal device of the embodiment has a clock circuit, and is configured so that, when the sub-display section 13 is set to display the time by operating the operation section 9, the sub-display section 13 displays the time in the standby state where the housings 1, 2 are closed as shown in FIG. 6. In a state where the housings 1, 2 are opened (step S2), the main display section 4 performs the standby display such as the time (step S6). At this time, although not illustrated, when the power source is turned OFF by, for example, pressing a power source button (step 4), the portable terminal device is ended (step S5).

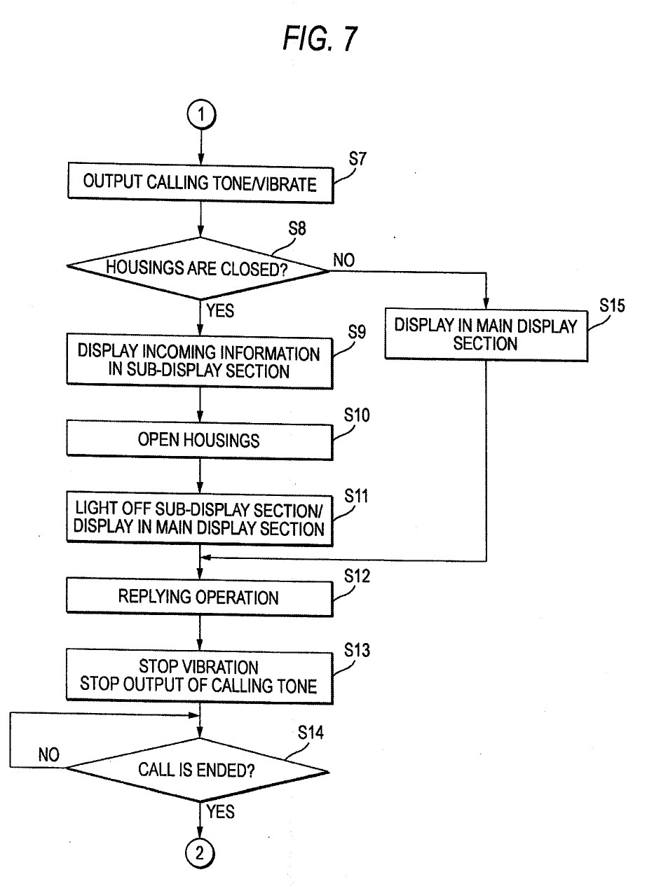

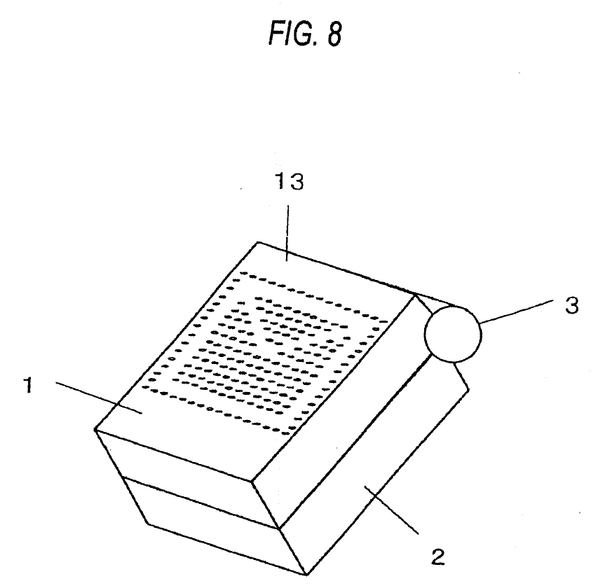

Next, telephone communication in the portable terminal device of the embodiment will be described with reference to FIGS. 5 and 7.

The portable terminal device can perform telephone communication with the partner through the radio transmitting and receiving section 14. When there is a telephone call from the partner (step S1), the process is transferred to step S7 of the flowchart of FIG. 7, an incoming signal is received by the radio transmitting and receiving section 14, and the controlling section 21 controls the calling signal outputting section 18 so as to output a predetermined calling signal. When the predetermined calling signal is output from the calling signal outputting section 18, the speaker 19 outputs a predetermined calling tone, and the vibrator 20 vibrates (step S7).

In the case where the housings 1, 2 are closed when there is a telephone call from the partner (step S8), the controlling section 21 controls the sub-display section 13 so as to display the telephone number and name of the partner (step S9). Namely, in the case where the housings 1, 2 are closed when there is a telephone call from the partner, although not illustrated, the controlling section 21 determines that the housings 1, 2 are closed in the state where there is a telephone call from the partner, on the basis of an output of sensing means for sensing whether the housings 1, 2 are closed or opened. Under the control of the controlling section 21, then, the telephone number of the partner which is transmitted from a portable-telephone communication network via a base station that is not shown is output, or the name of the partner which is registered in the electronic telephone directory memory 22, and the like are output on the basis of the telephone number, and displayed in the sub-display section 13.

The display in the sub-display section 13 is performed by causing only required ones of the plural light emitting elements 11 to emit light, with using driving means (not shown) for, under the control of the controlling section 21, selectively driving the respective plural light emitting elements 11 to display arbitrary characters, numerals, symbols, a pattern, and the like. When only the required light emitting elements 11 are caused to emit light in this way, the light from the required light emitting elements 11 is emitted to the outside of the housing 1 through the transparent cover 1a. Therefore, the emitted light allows information such as the telephone number and name of the partner to be easily recognized.

In this case, it is possible also to make the required light emitting elements 11 blink at predetermined time intervals. When blinking is performed in this way, incoming can be displayed more clearly.

When the housings 1, 2 are opened (step S10) after the call from the partner is sensed as described above, the display in the sub-display section 13 disappears, and the telephone number and name of the partner and the like which have been displayed in the sub-display section 13 are displayed in the main display section 4 (step S11). When, in this state, an operation of replying to the calling from the partner is performed with using the operation section 9 (step S12), the output from the calling tone outputting section 18 is stopped under the control of the controlling section 21 to cancel the calling tone, the vibration is stopped, and the control of the controlling section 21 forms a communication circuit with the partner via the radio transmitting and receiving section 14 and the audio signal inputting and outputting section 15, and a communication state with the partner is established with using the microphone 16 and the receiver 17.

In the case where the housings 1, 2 are already opened when there is a telephone call from the partner (step S8), the controlling section 21 judges the situation, and, under the control of the controlling section 21, information such as the telephone number and name of the partner is directly displayed in the main display section 4 (step S15). In this case, therefore, the telephone number and name of the partner, and the like are checked on the main display section 4, and, when a reply operation is performed, a state where communication with the partner is enabled is similarly established with using the microphone 16 and the receiver 17.

In the case where there is a telephone call from the partner in a state where the housings 1, 2 are mutually closed, therefore, the controlling section 21 controls the display in the sub-display section 13 to be automatically switched from the display of the time, characters, or a pattern to that of the telephone number and name of the partner.

When, after the communication state with the partner is established, a termination key which is one of the function keys 7 is operated, or the partner ends the call, the call is ended (step 14), and the process is returned to the standby state (step S1).

When a call is to be made to the partner, the housings 1, 2 are opened, and the telephone number of the partner is input with using the operation section 9. Alternatively, the telephone number of the partner is read from the electronic telephone directory memory 22, and displayed in the main display section 4. In this state, a transmission key which is one of the function keys 7 is operated. When the transmission key is operated, the partner's telephone number which is displayed in the main display section 4 is transmitted under the control of the controlling section 21 from the radio transmitting and receiving section 14 to the portable-telephone communication network via the base station that is not shown, thereby calling the partner. When the partner replies to the calling, information indicative of this is transmitted from the portable-telephone communication network, and received by the radio transmitting and receiving section 14, and, under the control of the controlling section 21, communication with the partner is enabled via the microphone 16 and the receiver 17.

In the embodiment, when the display in the sub-display section 13 is preset by an operation of the operation section 9, the display can be performed so that it flows from one side to another side as in an electric billboard. In the case of such setting, therefore, the display can be performed so as to flow while the display itself is expanded to full of the sub-display section 13. Therefore, the time, the telephone number, the name, and the like can be correctly checked without error.

Furthermore, when the display in the sub-display section 13 is preset by an operation of the operation section 9, the number of light emitting elements which perform light emission can be changed without altering the number of the light emitting elements of the device in order to display characters, numerals, a pattern, or the like. Therefore, characters, numerals, a pattern, or the like can be displayed in a reduced size, so that the light emitting elements can perform a display of plural lines or plural characters, or characters, numerals, symbols, a pattern, or the like can be displayed in an expanded size, so that the display is performed by the whole of the light emitting elements. The size of displayed information can be arbitrarily changed.

According to the embodiment, at call incoming, the sub-display section 13 can display the telephone number and name of the partner, or the like so as to be defined against the background. The embodiment has an effect that incoming can be easily sensed without additionally disposing light emitting diodes for displaying incoming.

As described above, the embodiment has the transparent cover 1a in the face which constitutes the outer side of the housing 1 in a state where the housings are closed. Between the transparent cover 1a and the housing 1, the many light emitting diodes are arranged in a matrix form to constitute the sub-display section 13. The sub-display section 13 can be formed in an arbitrary size, and displayed characters, numerals, a pattern, and the like can be displayed in a flowing manner, and characters, numerals, a pattern, and the I like are displayed so as to be defined against the background through the transparent cover 1a. The embodiment has an advantage that the display is very unique and easy to see.

In the embodiment, light emitting diodes are used as the light emitting elements 11. Alternatively, organic ELs or other light emitting elements may be used. When organic ELs are used as the light emitting elements, miniaturization and cost reduction are enabled. The embodiment describes simply that light emitting elements are used. Alternatively, they may be light emitting elements which emit the three primary colors, respectively. In the case of light emitting elements which respectively emit the three primary colors, the light emitting elements may be combined with each other to form a sub-display section which can perform a color display. In the case where organic ELs are used as the light emitting elements, plural pixels of organic ELs are bundled to be set as one display region corresponding to one LED pixel, and light emission is controlled in the unit of one display region. Therefore, a display can be performed while expanding the pixel size.

In the embodiment, the transparent cover 1a is disposed in the middle portion of the face which constitutes the outer side of the housing 1 in a state where the housings are closed, and, between the transparent cover 1a and the housing 1, the many light emitting diodes are arranged in a matrix form. However, the transparent cover 1a is not restricted to the middle portion of the face which constitutes the outer side of the housing 1 in a state where the housings are closed, and may be another portion. Alternatively, the cover may be the whole of a face which constitutes the outer side of the housings 1, 2 in a state where the housings are closed. The degree of the transparency of the transparent cover 1a is set so that light of the light emitting elements can be seen from the outside. The cover may be transparent. The color of the transparent cover 1a may be different from that of a portion other than the transparent cover 1a, or may be the same color. In the case of the same color, when characters, numerals, a pattern, or the like are not displayed, the cover looks merely as the housing, is simple in design, and will be noticed as a display portion only after characters, numerals, a pattern, or the like are displayed. Therefore, it is possible to present uniquenesss which is different from a liquid crystal display device of a conventional portable terminal.

### Embodiment 2

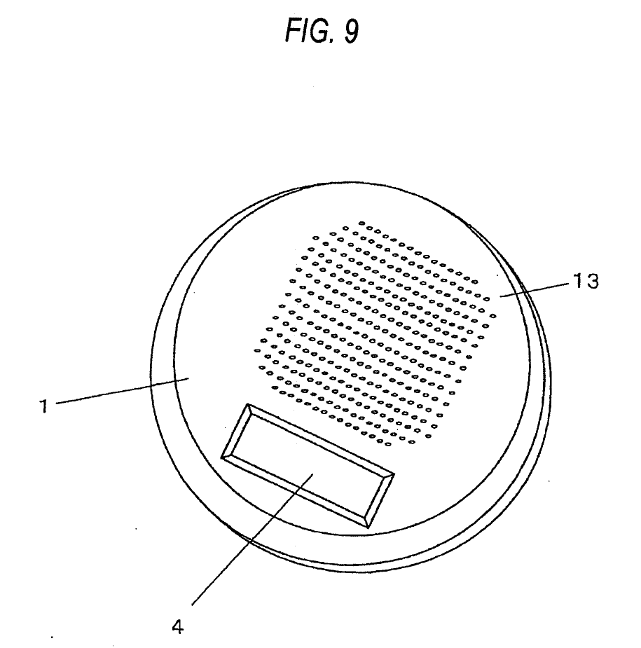

A portable terminal device of a second embodiment of the invention will be described. The portable terminal device of the second embodiment of the invention is provided with an electronic mail function, and configured so that an incoming state of an electronic mail is displayed. When a mail is received, for example, a pattern of an envelope can be displayed as shown in FIG. 8. In FIG. 8, display is performed while a portion of a contour of the envelope pattern is lighted off and another portion is lighted on. When the already-described light emitting elements which can perform a color display are used, therefore, it is possible to perform a display of various colors.

The terminal device may be configured so that, in a state where the housings 1, 2 are opened, the Internet, a game, a camera, and other functions can be adequately performed. When it is configured so that information, a game, or the like which is obtained through an electronic mail or the Internet is displayed in the sub-display section 13 in accordance with an operation on the operation section 9 and then used, a more unique portable terminal device can be attained.

### Embodiment 3

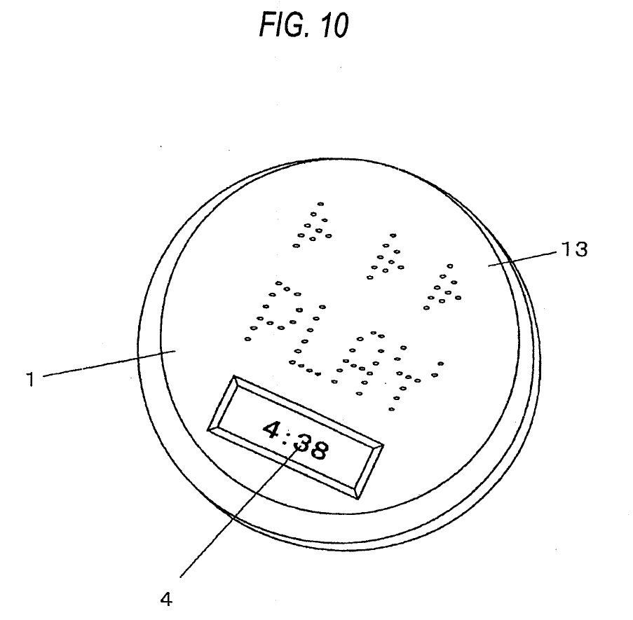

FIG. 9 is a perspective view of a portable terminal device of a third embodiment of the invention. The portable terminal device of the third embodiment of the invention has a function of reproducing an audio CD, and displays the status of the device, information of an inserted CD, or the like in the sub-display section 13. When an audio CD is being reproduced, for example, information of the playing time is displayed in the main display section 4 as shown in FIG. 10, and information indicative of reproducing is displayed in the sub-display section 13. Therefore, it is possible to display plural sets of information.

### Embodiment 4

Next, a portable telephone device of a fourth embodiment of the invention will be described. The portable telephone device of the embodiment has a configuration which is similar to that of the portable terminal device shown in FIG. 1. Hereinafter, description will be made with a focus on points different from the portable terminal device shown in FIG. 1. In addition to the configuration of the portable terminal device of FIG. 1, the portable telephone device of the embodiment comprises: means for sensing an event such as incoming or communication of a telephone or a mail; and a table showing correspondences between an event and display data. The controlling section 21 (light emitting element driving means) in the embodiment refers the table, and performs a matrix display based on display data corresponding to an sensed event, in an emotion area 32 which will be described later.

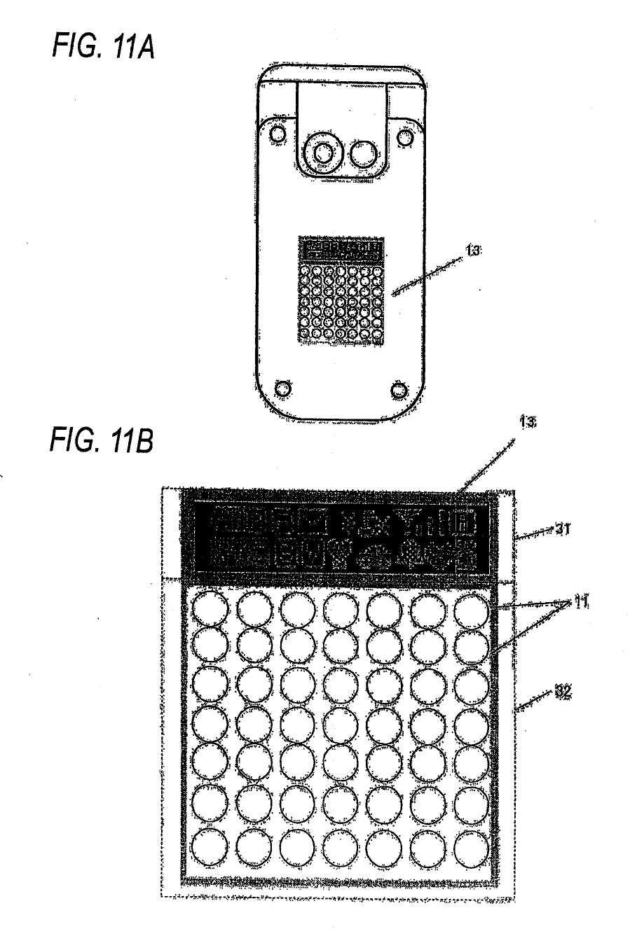

FIG. 11(a) shows the appearance of the portable telephone device of the fourth embodiment which is in a folded state. The sub-display section 13 of the portable telephone device of the embodiment is placed in a middle portion of the outer surface of the portable telephone device in order that the portion can be seen in a folded state.

FIG. 11(b) shows the configuration of the sub-display section 13. The sub-display section 13 in the embodiment performs a display separately in an information area 31 and the emotion area 32. The information area 31 performs an information display due to a liquid crystal display in a manner similar to the conventional art, such as a clock display, and a display of the status of the portable telephone device. As the status display, the sensitivity of an antenna, the remaining power of a battery, the name of the sender, existence of a call during absence, existence of a mail, and the like are displayed.

The emotion area 32 can perform a large or 7×7 dot matrix display, and display an original dot pattern favorite to the user, in response to an input of a predetermined format through the numeric keypad 8 and function keys 7 of the operation section 9 as described later.

The emotion area 32 is configured by, for example, light emitting diodes of 7×7 dots. The light emitting diodes can take either of a lighting mode which is similar to a firefly, a lighting mode in which visibility is enhanced, and a lighting mode in which the afterimage phenomenon is used, by controlling the level of the brightness. When three-color light emitting diodes are used, it is possible to express a colorful image.

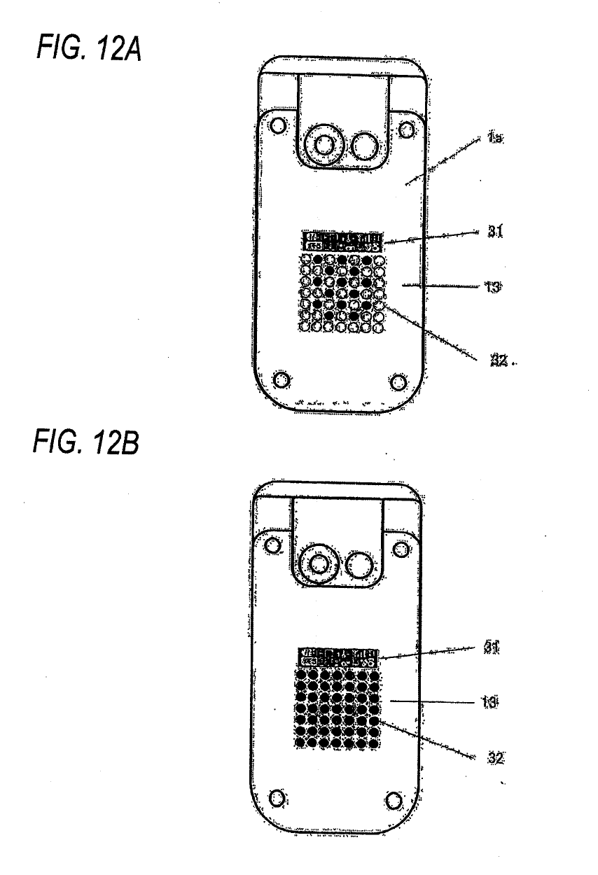

As shown FIG. 12(a), when linkage with the transparent cover (jacket) 1a which covers the sub-display section 13 is taken, filtering of emission colors of the light emitting diodes, that of the shape of light emission, and a combination of the pattern of the jacket and motion of light can be freely selected.

At call incoming, the colors, shapes, and motions of the light emitting diodes may be changed in accordance with the kind of the jacket or another surface (panel). For example, in the case where the panel is black, calm motion which expresses intelligence may be set, in the case where the panel is orange, the dot motion may be made quick so that active feeling is expressed, and in the case where the panel is white, the color and the motion may be made to produce a cute feeling.

In the portable telephone device of the embodiment, determination of the format of display data of the emotion area 32 enables an original dot pattern favorite to the user to be input through the numeric keypad 8 and function keys 7 of the operation section 9. Furthermore, formatted dot pattern data can be freely transferred from contents of a personal computer (PC), another portable telephone device, or an Internet site (Web).

In this case, a dot pattern has a small amount of data, and hence the data can be directly reproduced without being once stored in the portable telephone device. Therefore, formatted dot pattern display data are transmitted with being attached to a mail, and, in a portable telephone device which receives the mail, it is possible to see the dot pattern before reading the body text of the mail. This operation will be described later. Since the dot pattern can be easily produced by the sender, the emotion and atmosphere which cannot be told only by the body text of the mail can be freely expressed.

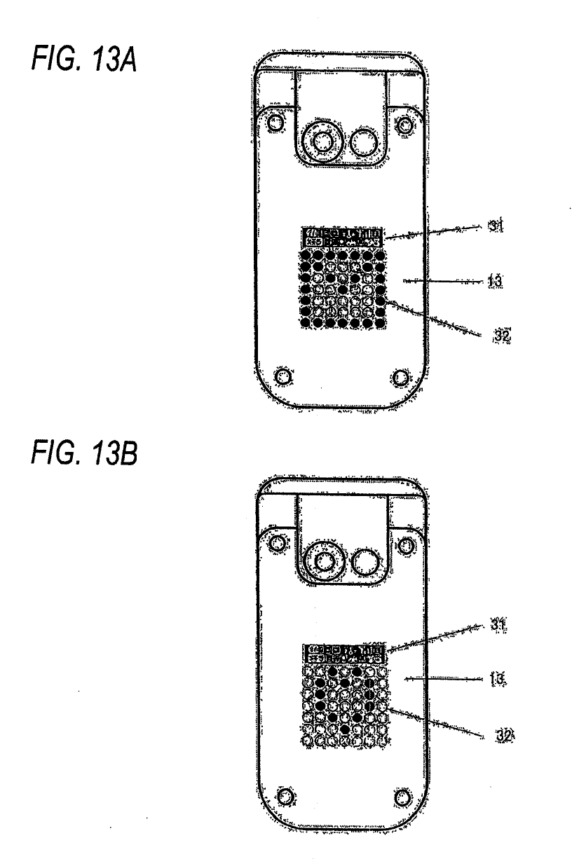

In this way, the owner of the portable telephone device can freely display an original pattern in the emotion area 32. Therefore, it is possible to perform a display which leads to emotional attachment to the portable telephone device. For example, a mode is enabled in which, when a mail arrives at the other party, the sub-display section 13 of the portable telephone device is caused to blink in accordance with pictograms used in the body text of the mail, as expression of the feeling. In accordance with capturing of the mail, namely, all the light emitting diodes of the 49 cells may be lighted on as shown in FIG. 12(b), or lighting is performed so that a mail mark expressing the contour of an envelope is defined against the background as shown in FIG. 13(a).

When the sender of a mail conducts predetermined setting relating to the table from the operation section 9 in accordance with a format, emotions of delight, anger, sorrow, and pleasure can be expressed in conjunction with the contents of the mail. In the case where delight is to be expressed, for example, the mail mark may move as if it hops, and, in the case where feeling of anger is to be expressed, the mail mark may glow red and move as if it pops. In the case where feeling of sorrow is to be expressed, the mail mark may move as if it collapses, and, in the case of feeling of pleasure, the mail mark may glow yellow.

Furthermore, “standby dot animation” which displays animations in the emotion area 32 during a standby period may be originally produced. Namely, a still dot image of 7×7 cells is produced with using an effect template, whereby animations such as swing and fade-out can be easily produced.

Alternatively, such animations may be downloaded from a predetermined site. Furthermore, “incoming dot animation” which is displayed in the case of incoming of a telephone call or a mail may be originally produced. For example, FIG. 13(b) shows a heart mark (still dot image) at incoming of a telephone call. The heart mark is produced with using an effect template, and caused to make a movement such as swing and fade-out, whereby the sense of anticipation at incoming of a telephone call can be presented. Also animation data in this case can be downloaded from a predetermined site.

When an original pattern is displayed in the emotion area 32, it is possible to present so that the user assumes the portable telephone device as a pet or empathizes with the portable telephone device. Namely, a table (a table showing correspondences between a status display and display data) in which the status display such as the sensitivity of an antenna displayed in the information area 31 is used as a parameter is provided, whereby expression of “emotion” can be presented.

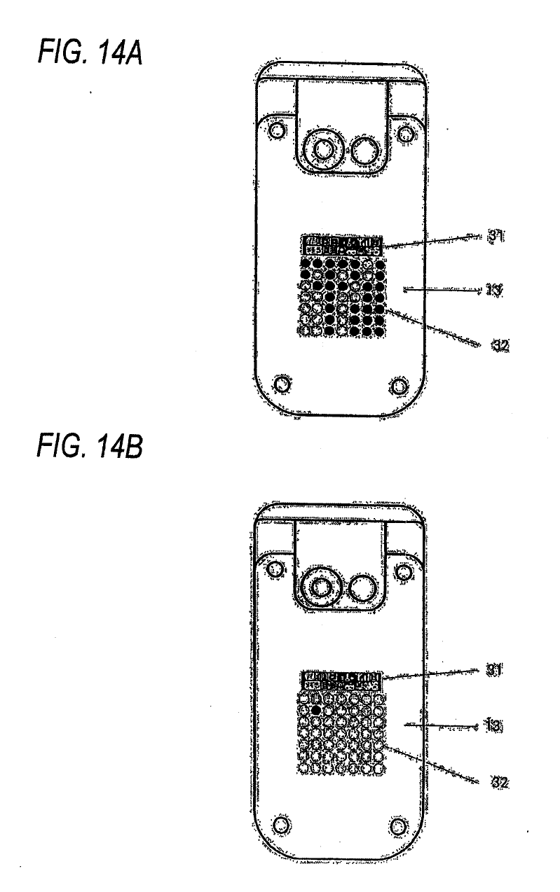

For example, the antenna sensitivity is displayed in the information area 31. However, the display is so small that it is not conspicuous. As shown in FIG. 14(a), an icon is displayed in a large size in the emotion area 32, so that visibility can be improved. In the case where, for example, the portable telephone device is out of communication range or the remaining power of a battery is small, particularly, this is displayed in a large size in the emotion area 32, whereby the user can be surely informed of this.

According to the setting of the table, when the portable telephone device is used, the light emitting diodes of the emotion area 32 are caused to sequentially blink at minute time intervals, whereby an image which is reminiscent of the use can be displayed. In accordance with the use mode of the portable telephone device such as transmission/speech/search for a base station/inquiry to the center/acquisition of information/non-contact IC/face authentication/music reproduction/speech recognition, the use of these functions is displayed, whereby presentment for enhancing emotional attachment to the portable telephone device can be performed. Furthermore, feeling of dynamic movement during use can be expressed.

During a call, for example, one dot of the emotion area 32 is irregularly moved as shown in FIG. 14(b), the speed of the movement is varied in accordance with the voice volume, the light intensity is changed in accordance with the radio wave condition, or the number of dots is increased in accordance with the call time.

During a standby period, hard beat or the heartbeat is expressed by lighting on four cells of the emotion area 32, so that the portable telephone device can be presented to be assumed as a pet. The lighting during a standby period requires an OFF function because of the relationship with respect to the standby time. When the use of the portable telephone device is to be ended, different displays may be performed when the portable telephone device is closed, in accordance with the use mode such as speech, site browsing, or the use of a camera.

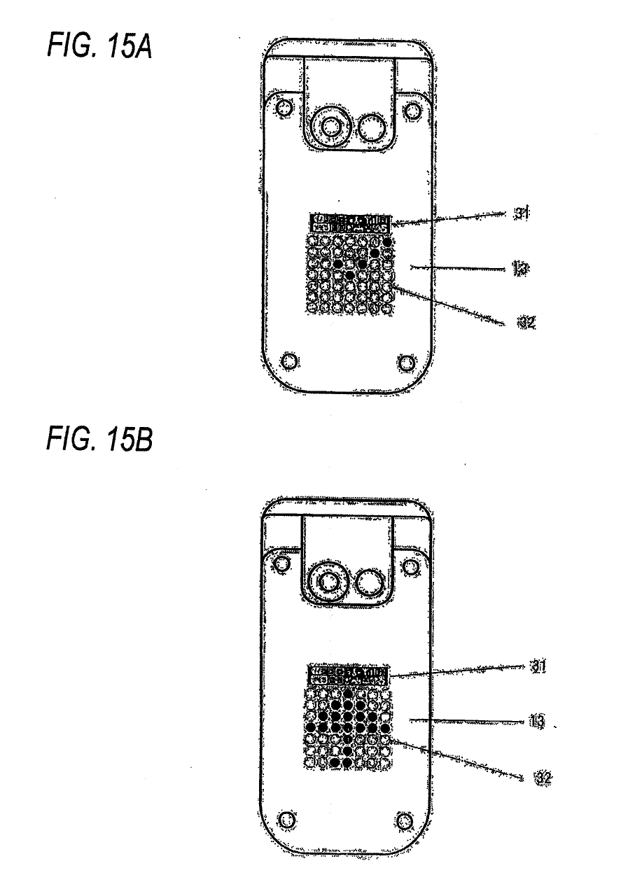

The portable telephone device may comprise a table showing correspondences between the time and the date, and display data, so that attention according to the use environment can be expressed. In the case where the time is periodically displayed, for example, the emotion area 32 periodically performs a time display in a manner similar to a cuckoo clock as shown in FIG. 15(a), and a relaxed atmosphere can be presented. The time may be checked by pressing a side button. At night, the time may be displayed at predetermined time intervals, so that the time passage is casually informed.

In order to express the sense of the season by using three-color light emitting diodes, the diodes are lighted in blue in summer, and in orange in winter in conjunction with the calendar function of the portable telephone device, to enable presentation suitable to the sense of the season to be performed. As the information display, for example, a weather forecast obtained from a weather forecast site is displayed by an umbrella mark, a sun mark, or the like as shown in FIG. 15(b), and an emotion of delight can be presented.

In this way, the portable telephone device of the embodiment can display a motion picture of a 7×7 dot matrix display in the emotion area 32. When data to be displayed in the emotion area 32 are formatted, it is possible to produce, correct, accumulate, and transfer display data of an original design.

In the portable telephone device of the embodiment, the above-mentioned functions are executed by the controlling section 21 in accordance with programs stored in the internal memory of the portable telephone device. The controlling section 21 has: a light emitting element driving function of selectively driving the respective plural light emitting elements included in the main display section 4 and the sub-display section 13 to cause the elements to display predetermined information; a function of converting a 7×7 dot matrix display in the emotion area 32 to formatted display data; that of converting formatted display data to a 7×7 dot matrix display; and that of producing formatted display data in the operation section 9 of the portable telephone device.

The controlling section 21 further has: a function of reading/writing formatted display data from and into the internal memory of the portable telephone device; that of obtaining formatted display data from the Web with using a transmitting and receiving function of the portable telephone device; that of transferring formatted display data between portable telephone devices with using the transmitting and receiving function of the portable telephone device; and that of reading/writing formatted display data from and into an external memory of the portable telephone device.

The controlling section 21 further has: a function of converting formatted display data which are produced by a personal computer to matrix display data; that of transferring formatted display data by an external I/F (USB, IrDA, or the like) of the portable telephone device; that of attaching display information to mail information which is sent in transmission of a mail (in transmission of a voice call), and previously displaying in the emotion area 32 from the information at call incoming; and that of performing a 7×7 dot matrix display in the emotion area 32 when a predetermined event is detected by an external sensor (a microphone, a camera, a radio receiving section, or the like) disposed in the portable telephone device.

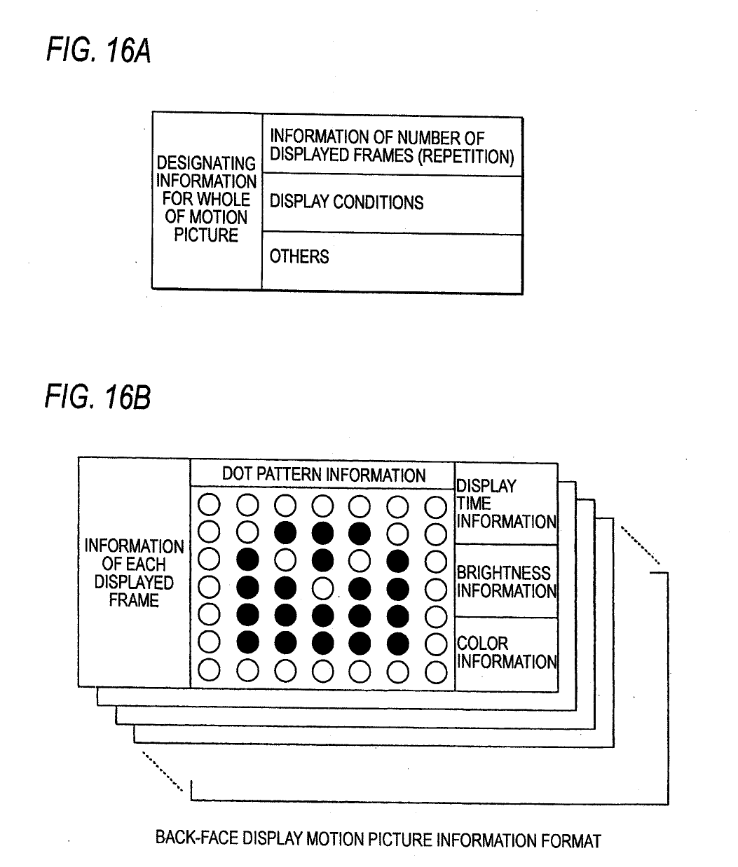

FIG. 16 shows one example of a back-face display motion picture information format for performing a matrix display in the emotion area 32 of the sub-display section 13 in the portable telephone device of the embodiment. FIG. 16(a) shows a format of designation information for the whole of a motion picture and designating information of the number of displayed frames (repetition), display conditions, etc.

FIG. 16(b) shows information of each displayed frame and including dot pattern information, display time information, brightness information, and color information.

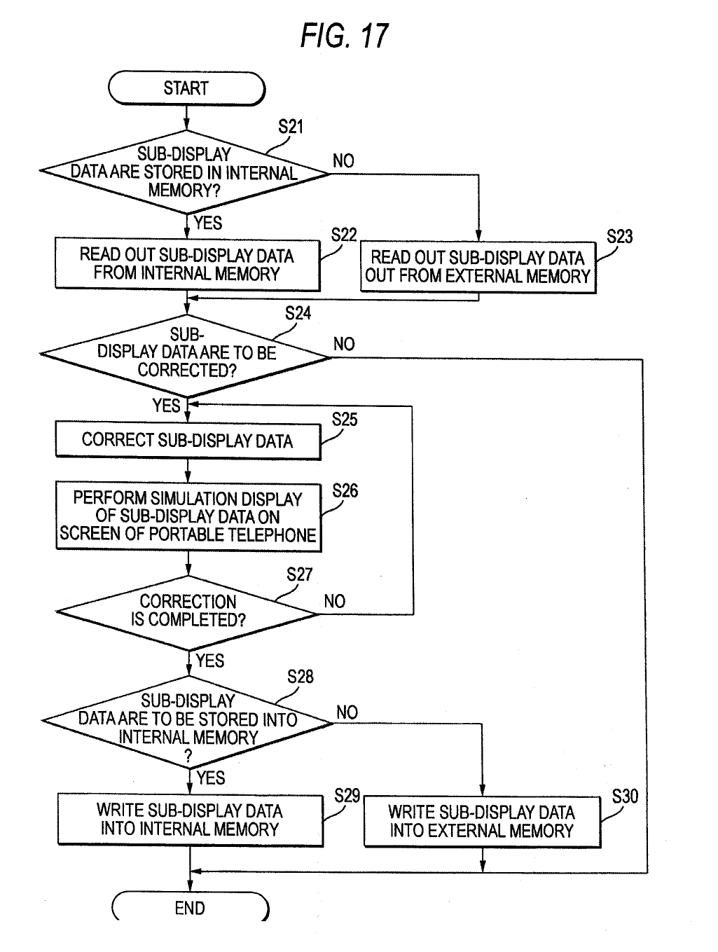

FIG. 17 is a flowchart showing operations of, in the portable telephone device of the embodiment, correcting and storing sub-display data into the internal memory or the external memory (memory card or the like).

In the case where sub-display data are to be corrected and stored into the internal memory or the external memory, the controlling section 21 first determines whether sub-display data are stored in the internal memory or not (step S21). If sub-display data are stored in the internal memory, the sub-display data are read out from the internal memory (step S22), and, if sub-display data are stored in the external memory, the sub-display data are read out from the external memory (step S23).

Next, it is determined whether the sub-display data are to be corrected or not (step S24). If to be corrected, the sub-display data are corrected (step S25). Then, a simulation display of the sub-display data is performed on a screen of the portable telephone device (step S26), and it is determined whether correction is completed or not (step S27).

Next, it is determined whether the corrected sub-display data are to be stored into the internal memory or not (step S28). If to be stored into the internal memory, the sub-display data are written into the internal memory (step S29), and, if to be stored into the external memory, the sub-display data are written into the external memory (step S30).

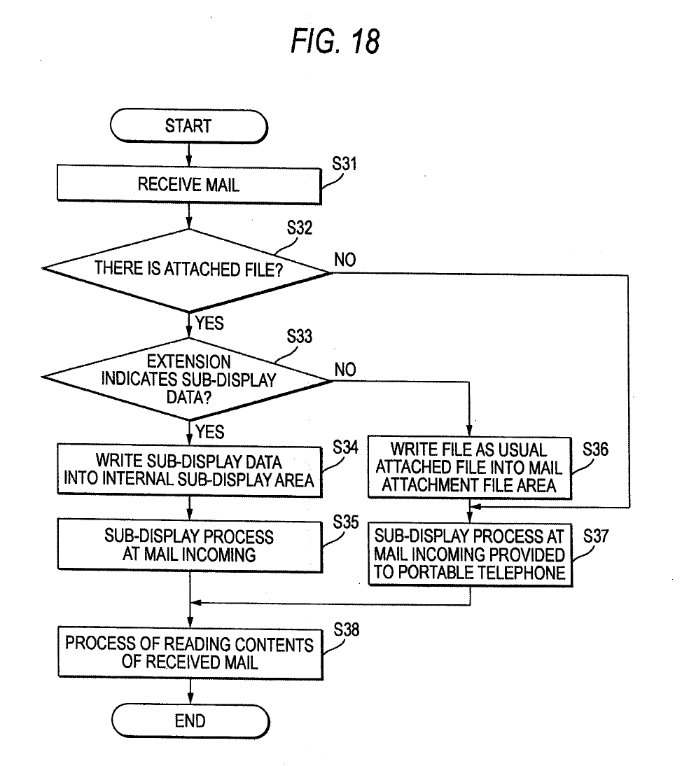

FIG. 18 is a flowchart showing an operation of, in the portable telephone device of the embodiment, performing an automatic reproducing display based on sub-display information of the sender at incoming of a mail. When a mail is received in the portable telephone device of the embodiment (step S31), it is determined whether there is a file attached to the mail or not (step S32). If there is an attached file, it is determined whether the extension indicates sub-display data or not (step S33).

If the extension indicates sub-display data, the sub-display data are written into an internal sub-display area (step S34), and a sub-display process at mail incoming is conducted (step S35). By contrast, if the extension does not indicate sub-display data in step S33, the file is written as a usual attached file into a mail attachment file area (step S36), and a sub-display process at mail incoming provided to the portable telephone device is conducted (step S37). Also in the case where it is determined in step S32 that there is not an attached file, the sub-display process at mail incoming provided to the portable telephone device is conducted (step S37). Next, a process of reading contents of the received mail is conducted (step S38), and the process is then ended.

As described above, according to the portable telephone device of the embodiment, a motion picture display due to plural light emitting elements 11 is performed in a part of the sub-display section 13, whereby a display of a high visual effect can be performed. Moreover, a creative and free display (expression) is enabled. When the displayed data are formatted, it is possible to produce, correct, accumulate, and transfer display data of an original design, and there is no restriction on the displayed time and place, so that the display can be performed in many places and times. Furthermore, display data indicative of the own sensitivity, feeling, sense, and the like can be produced easily and originally by oneself, and freely displayed on a back-face display of the portable telephone device.

According to the portable telephone device of the embodiment, since display data are formatted, display data can be produced and corrected by the portable telephone device or a personal computer (PC), and downloaded from Web contents. Moreover, display data can be transferred from a PC or another portable telephone device, and can be transferred also from an external memory such as a memory card, so that original display data can be freely handled.

Therefore, a matrix motion display which was produced by another person is obtained through various means, and corrected by oneself, whereby an original matrix motion display can be easily produced, and can be freely displayed on the back-face display of the portable telephone device.

According to the portable telephone device of the embodiment, when a mail is transmitted, display data may transmitted with being attached to the body text of the mail, and displayed at a timing of incoming. Before the recipient reads the mail, therefore, the display data are displayed on the back-face display of the portable telephone device, so that the recipient can previously understand the sense, feeling, and the like of the sender.

The portable telephone device of the embodiment comprises the table showing correspondences between sense outputs of the external sensor (a microphone, a camera, a radio receiving section, or the like) and display data. When the external sensor detects a predetermined event in conjunction with the external sensor, therefore, an original display can be performed. Consequently, a favorite display is performed in accordance with a predetermined change in conjunction with various sensors disposed in the portable telephone device, whereby display data can be displayed on the back-face display while the portable telephone device reacts as if it is a creature.

While the invention has been described in detail and with reference to the specific embodiments, it is obvious to those skilled in the art that various changes and modifications may be applied without departing from the sprit and scope of the invention.

The application is based on Japanese Patent Application (No. 2004-070449) filed Mar. 12, 2004 and Japanese Patent Application (No. 2004-206863) filed Jul. 14, 2004, and their disclosure is incorporated herein by reference.

### INDUSTRIAL APPLICABILITY

The portable terminal device of the invention comprises the light emitting element driving means for selectively driving the respective plural light emitting elements to cause the elements to perform a display based on display data, whereby a display can be performed while expanding the pixel size. Therefore, the invention has an effect that a display of a high visual effect can be performed, and can be applied to a portable terminal device such as a portable telephone device, a PDA, a portable CD player, and a game machine.

1-17. (canceled)

18. A portable terminal device having two or more display devices on a same face of a housing, wherein said portable terminal device comprises:
a first display device, configured by plural light emitting elements;
a light emitting element driver, selectively driving said respective plural light emitting elements; and
a second display device, and
said first display device and said second display device are placed to be adjacent to each other.

19. The portable terminal device according to claim 18, wherein said light emitting elements are intermittently lighted on.

20. The portable terminal device according to claim 19, wherein an area of a display region of said first display device is larger than an area of a display region of said second display device.

21. The portable terminal device according to claim 20, wherein a part of a display which is displayed on said second display device is displayed on said first display device while being expanded.

22. The portable terminal device according to claim 21, wherein the display data are attached to an electronic mail, and said device comprises an incoming processor for causing said first display device to display the display data, at a timing of incoming of the electronic mail.

23. The portable terminal device according to claim 21, wherein said device comprises:
an event sensor, sensing an event, and
a table, showing correspondences between the event and display data, and
said light emitting element driver refers said table, and causes a display based on display data corresponding to an event sensed by said event sensor to be performed.

24. The portable terminal device according to claim 23, wherein
said event sensor senses incoming, and
during incoming, said light emitting element driver causes a display based on display data corresponding to an incoming event to be performed.

25. The portable terminal device according to claim 23, wherein
said event sensor senses communication, and
during communication, said light emitting element driver causes a display based on display data corresponding to a communication event to be performed.

26. The portable terminal device according to claim 23, wherein
said device comprises a table showing correspondences between the time and the date, and display data, and
said light emitting element driver refers said table, and causes a display based on display data corresponding to the time and the date to be performed.

27. The portable terminal device according to claim 18, wherein said device comprises a producing and changing unit for producing and changing the display data.

28. The portable terminal device according to claim 18, wherein said light emitting element driver causes the plural display data to be sequentially displayed.

29. The portable terminal device according to claim 18, wherein said device further has a display device on a housing face which is opposed to a housing face having said first display device and said second display device.

30. A portable terminal device, wherein said portable terminal device comprises:
a display device configured by plural light emitting elements;
a light emitting element driver, selectively driving said respective plural light emitting elements;
a housing; and
a cover, disposed on a surface of said housing,
said display device is disposed on said housing surface, and a display screen of said display device is opposed to said cover.

31. The portable terminal device according to claim 30, wherein said cover transmits light emitted from said display device.

32. The portable terminal device according to claim 31, wherein a color of said cover is identical with a color of said housing.

33. The portable terminal device according to claim 30, wherein a part of said cover is formed as a through hole.

34. The portable terminal device according to claim 33, wherein said through hole is placed on said light emitting elements.
